(19) United States
(12) Patent Application Publication
(10) Pub. No.: US 2013/0083549 A1
(43) Pub. Date: Apr. 4, 2013

(54) LED LIGHTING DEVICE AND LED LUMINAIRE

(71) Applicants: Yuichiro Takahara, Yokosuka-shi (JP); Masahiko Kamata, Yokosuka-shi (JP); Hiroshi Matsushita, Yokosuka-shi (JP); Hiromichi Nakajima, Yokosuka-shi (JP); Shigeru Osawa, Yokosuka-shi (JP); Shinichiro Matsumoto, Yokosuka-shi (JP)

(72) Inventors: Yuichiro Takahara, Yokosuka-shi (JP); Masahiko Kamata, Yokosuka-shi (JP); Hiroshi Matsushita, Yokosuka-shi (JP); Hiromichi Nakajima, Yokosuka-shi (JP); Shigeru Osawa, Yokosuka-shi (JP); Shinichiro Matsumoto, Yokosuka-shi (JP)

(73) Assignee: TOSHIBA LIGHTING & TECHNOLOGY CORPORATION, Yokosuka-shi (JP)

(21) Appl. No.: 13/598,150

(22) Filed: Aug. 29, 2012

(30) Foreign Application Priority Data
Sep. 30, 2011 (JP) 2011-217441

(51) Int. Cl. F21V 29/00

(52) U.S. Cl. 362/382

(57) ABSTRACT

According to one embodiment, the device main body includes a main body portion, a protruding portion, and a heat conducting portion. The main body portion has an opening on one end side and has a wall portion on the other end side that is opposite to the opening side. The protruding portion protrudes from the wall portion and an inside thereof continues into the main body portion. The heat conducting portion has one end side thereof protruding from the wall portion toward the opening and has the other end side thereof connected to the protruding portion in a way that enables heat conduction. The light emitting unit is connected to the one end side of the heat conducting portion in a way that enables heat conduction. The lighting unit is housed inside the device main body and a portion of the lighting circuit component is arranged inside the protruding portion.

### INCORPORATION BY REFERENCE

The present invention claims priority under 35 U.S.C. §119 to Japanese Patent Application No. 2011-217441 filed on Sep. 30, 2011. The content of the application is incorporated herein by reference in their entirety.

### FIELD

Embodiments described herein relate generally to an LED lighting device and an LED luminaire in which heat from a light emitting unit that radiates illumination light is radiated via a heat conducting portion.

### BACKGROUND

According to a related art, a flat-type lamp device as an LED lighting device includes a flat casing having a protruding portion which cylindrically protrudes from a center side on a top surface of a substantially cylindrical body, for example, as in a lamp device using a GX53-type cap. A module board on which an LED is mounted and a lighting unit which turns on the LED are arranged inside the protruding portion or near the protruding portion.

### BRIEF DESCRIPTION OF THE DRAWINGS

FIG. 1 is a schematic front view of an LED lighting device according to a first embodiment.

FIG. 2(a) is a schematic plan view of the LED lighting device. FIG. 2(b) is a schematic bottom view of the LED lighting device.

FIG. 3 is a schematic sectional view of the LED lighting device.

FIG. 4 is a partly cut-out schematic side view of an LED luminaire using the LED lighting device.

FIG. 5 is a schematic sectional view of an LED lighting device according to a second embodiment.

### DETAILED DESCRIPTION

In general, according to one embodiment, an LED lighting device includes a light emitting unit, a lighting unit, and a device main body. The light emitting unit includes an LED. The lighting unit includes a lighting circuit component. The device main body includes a main body portion, a protruding portion, and a heat conducting portion. The main body portion has an opening on one end side and has a wall portion on the other end side that is opposite to the opening side. The protruding portion protrudes from the wall portion and an inside thereof continues into the main body portion. The heat conducting portion has one end side thereof protruding from the wall portion toward the opening and has the other end side thereof connected to the protruding portion in a way that enables heat conduction. The light emitting unit is connected to the one end side of the heat conducting portion in a way that enables heat conduction. The lighting unit is housed inside the device main body and at least a portion of the lighting circuit component is arranged inside the protruding portion.

With this configuration, the thermal radiation capability of the heat conducting portion to radiate heat generated by the light emitting unit can be secured, and the device main body can be provided in a small size and thickness by arranging the lighting circuit component inside the protruding portion. Moreover, since the distance between the light emitting unit and the opening of the device main body can be reduced, extraction efficiency of radiated light from the LED can be improved. Also, as the light emitting unit and the lighting unit are close to each other, electrical connection between the light emitting unit and the lighting unit can be made easier.

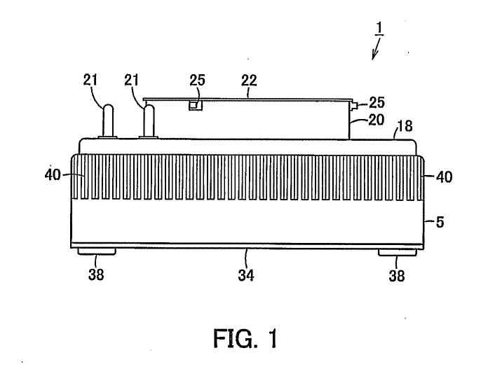

Hereinafter, a first embodiment will be described with reference to FIGS. 1 to 4.

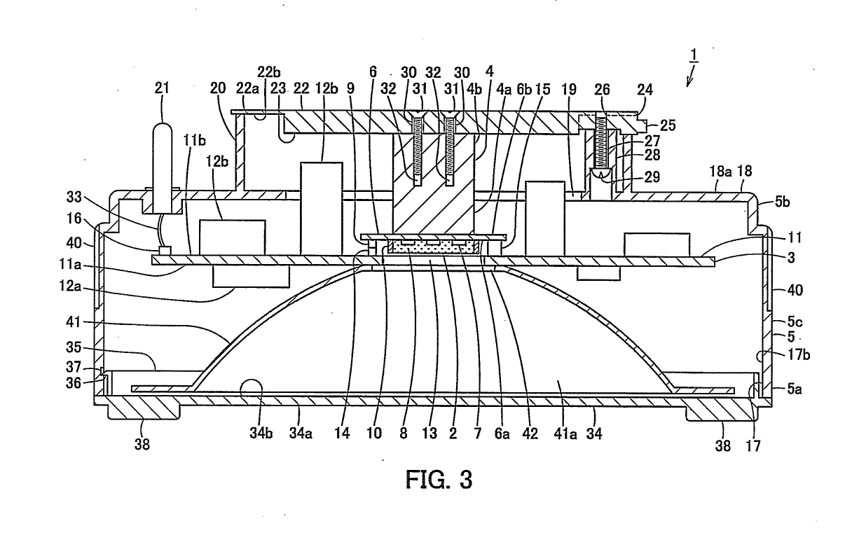

As shown in FIGS. 1 to 3, an LED lighting device of this embodiment is a lamp device 1. In FIG. 3, the lamp device 1 includes a light emitting unit 2, a lighting unit 3, a heat conducting member 4 forming a part of a heat conducting portion, and a device main body 5.

The light emitting unit 2 has a flat board 6, plural LED bare chips 7 as LEDs (light-emitting diodes) provided on one surface (one end-side surface) 6a of the board 6, and a sealing resin 8 covering the plural LED bare chips 7. The board 6 is made up of, for example, a substantially rectangular aluminum (Al) board. On the one surface 6a of the board 6, a wiring pattern, not shown, is formed via an insulating layer, and the plural LED bare chips 7 are mounted. The plural LED bare chips 7 are connected in series by the wiring pattern. Also, on the one surface 6a of the board 6, a pair of input terminals 9, 9 (in FIG. 3, only one input terminal 9 is shown) are provided so as to be electrically connected to the wiring pattern. The pair of input terminals 9, 9 are connected between both ends of the LED bare chips 7 connected in series.

The LED bare chips 7 are mounted on the one surface 6a of the flat board 6 and provided in a planar form. That is, the LED bare chips 7 are mounted on the board 6, for example, in a matrix form. The LED bare chips 7 radiate, for example, blue light. On the one surface 6a of the board 6, a frame portion 10 of, for example, a silicone resin, is formed in a rectangular shape surrounding the plural LED bare chips 7. The inside of the frame portion 10 is filled with the sealing resin 8 and the plural LED bare chips 7 are embedded in the sealing resin 8. An outer surface of the sealing resin 8 is formed flatly.

The sealing resin 8 is, for example, a light-transmitting silicone resin and contains a yellow phosphor, not shown. When blue light radiated from the plural LED bare chips 7 becomes incident on this yellow phosphor, the yellow phosphor transforms the wavelength of the blue light to yellow light. As this yellow light and the blue light radiated from the plural LED bare chips 7 are emitted from the outer surface of the sealing resin 8 and form a mixed color (mixed light), white light is radiated from the light emitting unit 2. The outer surface of the sealing resin 8 functions as a light emitting surface of the light emitting unit 2.

The light emitting unit 2 may have surface-mounted LEDs mounted on the side of the one surface 6a of the board 6. The light emitting unit 2 is mounted on a circuit board 11 of the lighting unit 3.

The lighting unit 3 has the flat circuit board 11 and lighting circuit components 12a, 12b mounted on each of one surface (one end-side surface) 11a and the other surface (other end-side surface) 11b of the circuit board 11. The circuit board 11 is made of, for example, a glass epoxy material and is formed in a substantially circular shape. Also, a center hole 13 as a circular board opening is provided at a central part of the circuit board 11.

The lighting circuit components 12a, 12b form a lighting circuit via a wiring pattern, not shown, formed in the circuit board 11. This lighting circuit is made up of a known configuration which supplies a constant current to the LED bare chips 7 in the light emitting unit 2 and thus turns on the LED bare chips 7 (causes the LED bare chips 7 to emit light). A pair of output terminals 14, 14 in the lighting circuit (in FIG. 3, only one output terminal 14 is shown) are provided near the center hole 13 on the side of the one surface 11a of the circuit board 11.

On the side of the other surface 11b of the circuit board 11, the light emitting unit 2 is mounted via plural spacers 15. Here, the light emitting surface of the light emitting unit 2 faces the center hole 13, and the input terminals 9 of the light emitting unit 2 are, for example, soldered and thus electrically connected to the output terminals 14. Each of the spacers 15 is adhered to the side of the one surface 6a of the board 6 of the light emitting unit 2 and the side of the other surface 11b of the circuit board 11 with an adhesive and firmly bonds the board 6 and the circuit board 11. Thus, a constant current can be supplied to the LED bare chips 7 in the light emitting unit 2 from the lighting unit 3. An input terminal 16 of the lighting unit 3 is provided at an end part on the side of the other surface 11b of the circuit board 11.

The heat conducting member 4 is formed in a columnar shape using a heat-conductive metal, for example, aluminum (Al). The heat conducting member 4 is attached to the board 6 with an adhesive or the like in such a way that a surface on one end side 4a is arranged in tight contact with the other surface (other end-side surface) 6b of the board 6 of the light emitting unit 2. The heat conducting member 4 supports the light emitting unit 2 onto the device main body 5.

The device main body 5 is made of a synthetic resin, for example, polybutylene terephthalate (PBT) resin or the like. In the device main body 5, a substantially cylindrical main body portion 5c which has an opening 17 on one end side 5a, a flat portion 18 as a wall portion on the other end side 5b and a circular insertion portion 19 formed at a central part of the flat portion 18 is formed. On an outer surface 18a of the flat portion 18, a cylindrical protruding portion 20 protruding outward at a central part of the outer surface, and a pair of lamp pins 21, 21 near the protruding portion 20 (in FIG. 3, only one lamp pin 21 is shown) are arranged. In the protruding portion 20, a thermal radiation member 22 as a thermal radiation portion which forms a part of the heat conducting portion is provided. That is, the heat conducting member 4 and the thermal radiation member 22 form the heat conducting portion.

The thermal radiation member 22 is molded, for example, by aluminum die-casting and attached to a top surface of the protruding portion 20 in such a way as to face the insertion portion 19. On the side of an inner surface 22b of the thermal radiation member 22, an attachment portion 23 which is thick and has a rectangular parallelepiped shape is formed and protruding.

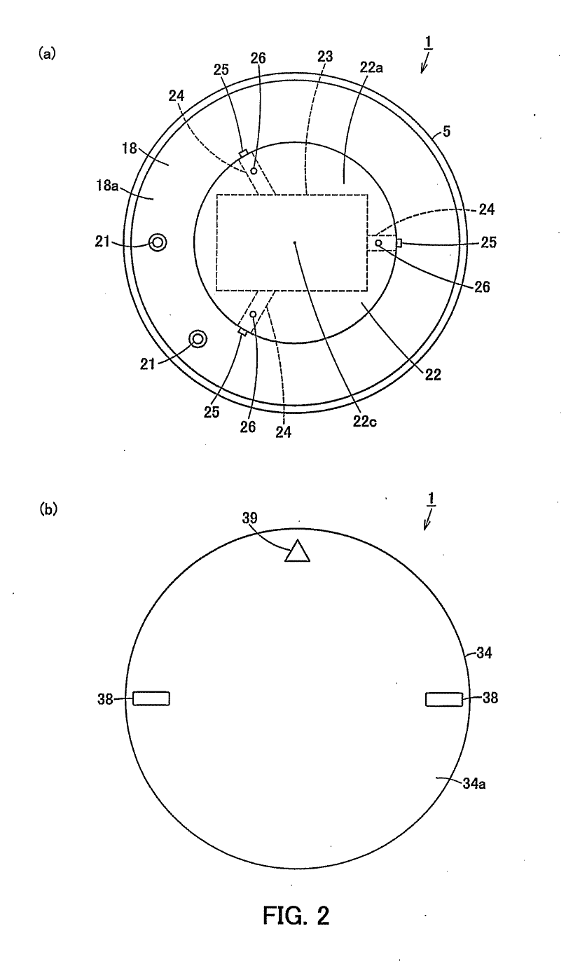

A substantially rectangular parallelepiped-shaped fixing portion 24 is formed from the attachment portion 23 toward an outer peripheral edge of the thermal radiation member 22. A key portion 25 is provided at a distal end of the fixing portion 24. Also, a screw hole 26 is provided in the fixing portion 24. As shown in FIG. 2(a), three fixing portions 24 are formed at a spacing of 120 degrees about a center 22c of the thermal radiation member 22.

As shown in FIG. 3, on the outer surface 18a of the flat portion 18, a columnar dowel 28 having a stepped through-hole 27 is formed and protruding so as to abut on the fixing portion 24. A screw 29 inserted in the through-hole 27 is tightened into the screw hole 26 of the fixing portion 24. Thus, the thermal radiation member 22 is attached to the protruding portion 20.

Screws 31, 31 are inserted from the side of an outer surface 22a into through-holes 30, 30 having recessed parts and formed in the attachment portion 23 of the thermal radiation member 22, and these screws 31, 31 are tightened into screw holes 32, 32 of the heat conducting member 4. Thus, the surface on the other end side 4b of the heat conducting member 4 tightly contacts the attachment portion 23, and the heat conducting member 4 is fixed on the thermal radiation member 22. That is, the heat conducting member 4 is fixed in the protruding portion 20 of the device main body 5 via the thermal radiation member 22. Also, the one end side 4a of the heat conducting member 4 is made to protrude further into the main body portion 5c than the flat portion 18.

Thus, the light emitting unit 2 and the lighting unit 3 supported by the head conducting member 4 and the thermal radiation member 22 are housed inside the main body portion 5c in such a way that radiated light from the light emitting unit 2 is emitted from the opening 17 of the device main body 5. The circuit board 11 of the lighting unit 3 is arranged inside the main body portion 5c from the flat portion 18. Of the plural lighting circuit components 12b mounted on the other surface 11b of the circuit board 11 facing the side of the flat portion 18, the lighting circuit component 12b having a great protrusion height from the circuit board 11 is arranged in a state of entering the inside of the protruding portion 20 through the insertion portion 19. In the lighting unit 3, the circuit board 11 may be further supported by another holding member provided inside the device main body 5.

The thermal radiation member 22 is slightly protruding from an outer peripheral surface of the protruding portion 20 into a normal direction to the outer peripheral surface, and the key portion 25 is protruding. The key portion 25 is inserted and attached in a key groove of a socket in which the lamp device 1 is installed.

A thermal radiation sheet, not shown, is arranged on the outer surface 22a of the thermal radiation member 20. The screw hole 26 in the thermal radiation member 22 is closed by the thermal radiation sheet.

The pair of lamp pins 21, 21 are made of, for example, brass. The lamp pins 21, 21 are formed substantially cylindrically with a substantially hemispherical top side and are provided near the protruding portion 20 and protruding upward from the outer surface 18a of the flat portion 18. The lamp pins 21, 21 are provided corresponding to the input terminals 16, 16 provided on the circuit board 11 of the lighting unit 3 and are provided at sites that are situated near the input terminals 16, 16 when the lighting unit 3 is housed inside the device main body 5. Lead wires 33 connected to the respective input terminals 16, 16 are inserted in the lamp pins 21, 21 and the lead wires 33 are soldered on the top side of the lamp pins 21, 21. Thus, the pair of lamp pins 21, 21 are electrically connected to the pair of input terminals 16, 16 of the lighting device 3.

In the opening 17 of the device main body 5, a protection cover 34 is attached. The protection cover 34 is formed by molding a light-transmitting resin, for example, polycarbonate (PC) resin. An outer surface 34a of the protection cover 34 is a flat surface and formed circularly. On an inner surface 34b of the protection cover 34, plural protruding members 35 along an inner surface 17b of the opening 17 are provided at intervals. Some the protruding members 35 have an engaging pawl 36, and the engaging pawl 36 is engaged with an engaging groove 37 formed on the inner surface 17b of the opening 17. Thus, the protection cover 34 is attached in the opening 17 of the device main body 5. The protection cover 34 is attached in such a way as to substantially close the inside of the device main body 5.

On a peripheral edge side of the outer surface 34a of the protection cover 34, rectangular parallelepiped-shaped finger hook portions 38, 38 are formed protruding. As shown in FIG. 2(b), the finger hook portions 38, 38 are provided rotationally symmetric by 180 degrees. Also, a triangular mark 39 indicating the installing position to an LED luminaire is provided on the peripheral edge side of the outer surface 34a of the protection cover 34.

As shown in FIG. 1, triangular recessed portions 40 are formed at predetermined intervals on an outer peripheral surface on the side of the flat portion 18 of the device main body 5.

Moreover, the device main body 5 houses a reflection mirror 41 as a light control unit, as shown in FIG. 3. The reflection mirror 41 is formed substantially elliptically and is provided in such a way as to be sandwiched between the circuit board 11 and the protection cover 34, with a top-side opening 42 facing the center hole 13 of the circuit board 11. That is, the reflection mirror 41 is arranged on the side of the other surface 11b of the circuit board 11. The reflection mirror 41 is formed, for example, by molding aluminum and an inner surface 41a is formed as a reflection surface.

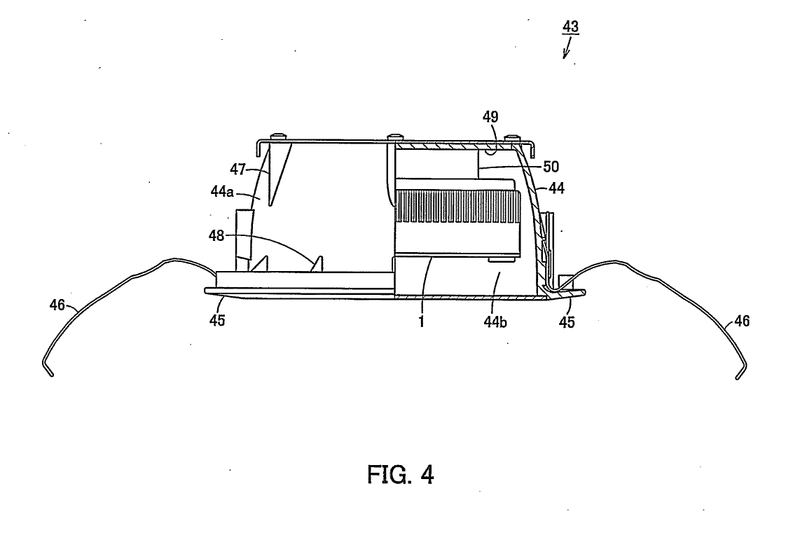

The lamp device 1 is installed in an LED luminaire 43, as shown in FIG. 4. This LED luminaire is a down-light embedded in a ceiling or the like and is installed on the ceiling or the like by a flange portion 45 and a pair of attachment springs 46, 46 provided on a luminaire main body 44.

The luminaire main body 44 is molded by aluminum die-casting and is formed in a substantially cylindrical case-like shape having reinforcement pieces 47, 48 which also function as thermal radiation fins on an outer surface 44a. An inner surface 44b of the luminaire main body 44 is formed as a reflection surface, for example, by white painting. A socket device 50 is arranged on the inner side of a top plate portion 49. The protruding portion 20 of the lamp device 1 is installed in this socket device 50. That is, the socket device 50 is formed with a known configuration for installing the protruding portion 20 of the lamp device 1.

The lamp device 1 is fixed to the socket device 50 by the key portion 25. On the inner surface 44b of the luminaire main body 44, an alignment mark, not shown, for alignment with the mark 39 on the lamp device 1 is provided.

Next, operations of the first embodiment will be described.

As an external power supply is introduced into the LED luminaire 43, the socket device 50 is supplied with electricity. An AC voltage (for example, AC 100 V) from the external power supply is inputted to the lighting unit 3 of the lamp device 1 via the pair of lamp pins 21, 21 and the lead wires 33, 33. In the lighting unit 3, the lighting circuit formed by the lighting circuit components 12a, 12b and the like operates and supplies a constant current to the light emitting unit 2 via the output terminals 14. Thus, the LED bare chips 7 turn on and white light is radiated from the light emitting unit 2. The radiated light passes through the center hole 13 of the circuit board 11, the top-side opening 42 of the reflection mirror 41 and the protection cover 34, is then emitted from the lamp device 1, and is emitted outward from the opening of the LED luminaire 43. This emitted light illuminates a surface to be irradiated, an object to be irradiated or the like that is present outside.

With the heat conducting member 4, the light emitting unit 2 is arranged toward the side of the main body portion 5c from the flat portion 18 of the device main body 5, and the distance between the light emitting unit 2 and the opening 17 of the device main body 5 (protection cover 34) is short. Because of this short distance, the reflection mirror 41 is formed substantially elliptically with a wide angle and has a low reflection rate to the radiated light from the light emitting unit 2. Therefore, the radiated light from the light emitting unit 2 is transmitted through the protection cover 34 and emitted from the opening 17 of the device main body 5 with little loss (attenuation), and the light extraction efficiency of the lamp device 1 is thus improved. Also, since the inside of the device main body 5 on the side of the opening 17 from the circuit board 11 is the installation space for the reflection mirror 41, the reflection mirror 41 can be formed in such a way as to distribute the radiated light from the light emitting unit 2 at a wide angle with little loss. The reflection mirror 41 can also be formed in such a way as to perform narrow-angle light distribution.

The light emitting unit 2 is arranged toward the side of the opening 17 from the flat portion 18 of the device main body 5 and therefore the distance between the light emitting unit 2 and the opening 17 of the device main body 5 is short. Moreover, of the plural lighting circuit components 12b mounted on the other surface 11b of the circuit board 11 on the side of the flat portion 18, the lighting circuit component 12b having a great protrusion height from the circuit board 11 is arranged in a state of partly entering the inside of the protruding portion 20 through the insertion portion 19. Therefore, the device main body 5 can be small in depth (height) dimension and hence the lamp device 1 can be provided in a small size and thickness.

As the LED bare chips 7 turn on, heat is generated in the light emitting unit 2. This heat is transferred to the heat conducting member 4 to which the light emitting unit 2 is attached, and the heat is transferred from the heat conducting member 4 to the thermal radiation member 22 of the device main body 5. The heat is then transferred from the thermal radiation member 22 to the socket device 50 and further transferred from the socket device 50 to the luminaire main body 44. The heat is then radiated into the air from the luminaire main body 44. Since both the heat conducting member 4 and the thermal radiation member 22 are made of a highly heat-conductive metal, for example, aluminum (Al), the heat generated in the light emitting unit 2 is quickly conducted and radiated outside of the lamp device 1. That is, the heat from the light emitting unit 2 is efficiently radiated by the heat conducting member 4 and the thermal radiation member 22 which have heat conductivity. Therefore, temperature rise in the light emitting unit 2 can be restrained and the light emitting unit 2 with a long life can be provided.

The light emitting unit 2 is mounted on the circuit board 11 of the lighting unit 3, and the output terminals 14 of the lighting unit 3 and the input terminals 9 of the light emitting unit 2 are electrically connected to each other. Therefore, the lighting unit 3 and the light emitting unit 2 can be electrically connected to each other easily.

According to the lamp device 1 of this embodiment, heat radiation capability to radiate the heat generated by the light emitting unit 2 can be secured by the heat conducting portion (heat conducting member 4 and thermal radiation member 22), and the device main body 5 can be provided in a small size and thickness by arranging the lighting circuit component 12b within the protruding portion 20. Moreover, the distance between the light emitting unit 2 and the opening 17 of the device main body 5 can be short. Therefore, extraction efficiency for radiated light from the LED can be improved. Also, since the light emitting unit 2 and the lighting unit 3 are close to each other, the light emitting unit 2 and the lighting unit 3 can be electrically connected to each other easily.

Also, in the lighting unit 3, the light emitting portion of the light emitting unit 2 faces the center hole 13 of the circuit board 11, and the light emitting unit 2 is mounted on the side of the other surface 11b of the circuit board 11 so that the input terminals 9 of the light emitting unit 2 are electrically connected to the output terminals 14. Therefore, the light emitting unit 2 and the lighting unit 3 can be electrically connected to each other easily and a small depth (height) dimension can be provided between the opening 17 of the device main body 5 and the thermal radiation member 22. Thus, the device main body 5 can be provided in a small size and thickness and the distance between the light emitting unit 2 and the opening 17 of the device main body 5 can be short. The extraction efficiency for radiated light from the light emitting unit 2 can be increased.

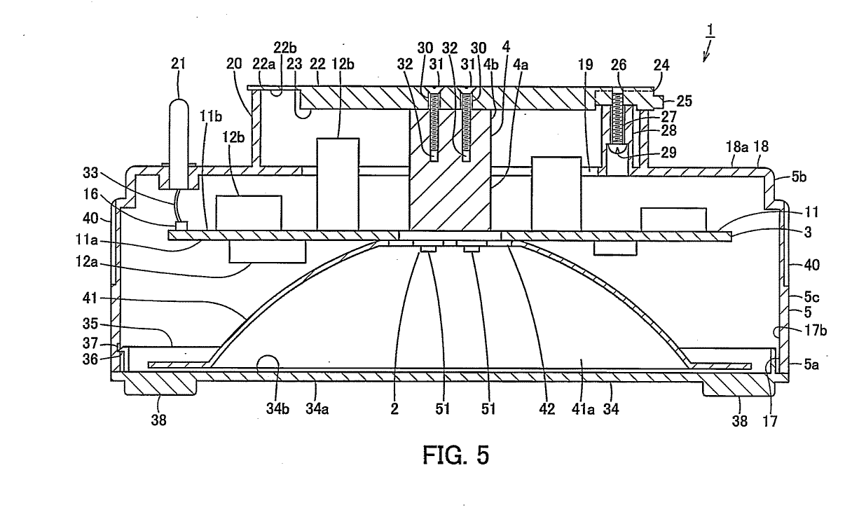

Next, a second embodiment will be described with reference to FIG. 5. The same parts as in the first embodiment and equivalent parts are denoted by the same reference numerals and will not be described further.

In FIG. 5, in the lamp device 1, the light emitting unit 2 is provided on the circuit board 11, compared with the lamp device 1 shown in FIG. 3. Moreover, surface-mounted LEDs 51 are used for the light emitting unit 2, and the circuit board 11 having no center hole 13 and having the two flat surfaces 11a, 11b is used.

Plural LEDs 51 are mounted in a central part of the one surface 11a of the circuit board 11. The lighting circuit components 12a, 12b are mounted on the two surfaces 11a, 11b except the area where the LEDs 51 are mounted and an area on the other surface 11b opposite to the LED-mounted area. The LEDs 51 are electrically connected to the lighting circuit formed by the lighting circuit components 12a, 12b via a wiring pattern, not shown.

The heat conducting member 4 is attached to an area on the side of the other surface 11b opposite to the area where the LEDs 51 are mounted, on the circuit board 11, via an adhesive, silicone or heat conductive material. The heat conducting member 4 supports the circuit board 11.

Heat generated by the lighting of the LEDs 51 is transferred from the circuit board 11 to the heat conducting member 4, then transferred from the heat conducting member 4 to the thermal radiation member 22 and thus radiated.

According to the lamp device 1 of this embodiment, the heat generated in the LEDs 51 mounted on the circuit board 11 is conducted from the circuit board 11 to the heat conducting member 4 and can be radiated from the thermal radiation member 22 of the device main body 5. Therefore, there is an advantage that temperature rise in the LEDs 51 can be retrained, enabling the LEDs 51 and the lighting unit 3 to have a long life.

Also, since the LEDs 51 are mounted on the circuit board 11 of the lighting unit 3, there is no need to make special efforts to electrically connect the LEDs 51 with the lighting unit 3. Therefore, there is an advantage that easy assembly and reduced cost of the lamp device 1 can be realized.

In the embodiment, the LED lighting device is the lamp device 1. However, the LED lighting device is not limited to this example and may be an LED luminaire including the device main body 5 configured in a luminaire main body or casing.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An LED lighting device comprising:
a light emitting unit comprising an LED;
a lighting unit which turns on the LED and comprises a lighting circuit component; and
a device main body comprising a main body portion which comprises an opening on one end side and comprises a wall portion on the other end side that is opposite to the opening side, a protruding portion which protrudes from the wall portion, with an inside of the protruding portion continuing into the main body portion, and a heat conducting portion with one end side thereof protruding from the wall portion toward the opening and with the other end side thereof connected to the protruding portion in a way that enables heat conduction, wherein the light emitting unit is connected to the one end side of the heat conducting portion in a way that enables heat conduction, and wherein the lighting unit is housed inside and at least a portion of the lighting circuit component is arranged inside the protruding portion.

2. The device according to claim 1, wherein the lighting unit comprises a circuit board on which the lighting circuit component is mounted, and
the circuit board is arranged toward the opening from the wall portion and the lighting circuit component is mounted on a surface on the side of the wall portion.

3. The device according to claim 2, wherein the light emitting unit comprises a board with the LED mounted on a surface on one end side and with a surface on the other end side connected to the heat conducting portion in a way that enables heat conduction, and an input terminal provided on the board, and
the circuit board comprises a board opening facing the light emitting unit and comprises an output terminal electrically connected to the input terminal.

4. The device according to claim 2, wherein the light emitting unit is configured as a part of the circuit board, the LED is mounted on a surface on one end side of the circuit board, and a surface on the other end side of the circuit board is connected to the heat conducting portion in a way that enables heat conduction.

5. The device according to claim 2, comprising a light control unit arranged between the opening and the circuit board.

6. An LED luminaire comprising:
a luminaire main body;
a socket device arranged in the luminaire main body; and
an LED lighting device comprising a light emitting unit which comprises an LED, a lighting unit which turns on the LED and comprises a lighting circuit component, and a device main body comprising a main body portion which comprises an opening on one end side and comprises a wall portion on the other end side that is opposite to the opening side, a protruding portion which protrudes from the wall portion, with an inside of the protruding portion continuing into the main body portion, and a heat conducting portion with one end side thereof protruding from the wall portion toward the opening and with the other end side thereof connected to the protruding portion in a way that enables heat conduction, wherein the light emitting unit is connected to the one end side of the heat conducting portion in a way that enables heat conduction, the lighting unit is housed inside, and at least a portion of the lighting circuit component is arranged inside the protruding portion, and wherein the LED lighting device is installed in the socket device.

7. The luminaire according to claim 6, wherein the lighting unit comprises a circuit board on which the lighting circuit component is mounted, and
the circuit board is arranged toward the opening from the wall portion and the lighting circuit component is mounted on a surface on the side of the wall portion.

8. The luminaire according to claim 7, wherein the light emitting unit comprises a board with the LED mounted on a surface on one end side and with a surface on the other end side connected to the heat conducting portion in a way that enables heat conduction, and an input terminal provided on the board, and
the circuit board comprises a board opening facing the light emitting unit and comprises an output terminal electrically connected to the input terminal.

9. The luminaire according to claim 7, wherein the light emitting unit is configured as a part of the circuit board, the LED is mounted on a surface on one end side of the circuit board, and a surface on the other end side of the circuit board is connected to the heat conducting portion in a way that enables heat conduction.

10. The luminaire according to claim 7, comprising a light control unit arranged between the opening and the circuit board.
